(19) United States
(12) Patent Application Publication
(10) Pub. No.: US 2008/0275951 A1
(43) Pub. Date: Nov. 6, 2008

(54) INTEGRATED LOGGING FOR REMOTE SCRIPT EXECUTION

(75) Inventors: John R. Hind, Raleigh, NC (US); Yongcheng Li, Cary, NC (US)

Correspondence Address: STEVENS & SHOWALTER, L.L.P., BOX IBM, 7019 CORPORATE WAY, DAYTON, OH, 45459-4238, US

(73) Assignee: INTERNATIONAL BUSINESS MACHINES CORPORATION, Armonk, NY (US)

(21) Appl. No.: 11/744,608

(22) Filed: May 4, 2007

(51) Int. Cl. G06F 15/16; G06F 15/173

(52) U.S. Cl. 709/204; 709/224

(57) ABSTRACT

An integrated logging system includes a client-side logging component and a server-side logging component. The client-side logging component possesses the capability of logging client-side activity information, such as may relate to the execution of a script or other suitable client-side code that is controlled and executed independently of a remote server associated with the server-side logging component. The client-side logging component may also communicate logged activity information back to the corresponding server-side logging component. Messages including logged client-side activity information are received from the client-side logging component by the server-side logging component, and the logged activity information is integrated into the server-side log(s) of a server-side logging system. Thus, activity information from an independently controlled and operated processing device, which may be used, for example for problem determination, is integrated from sources that are distributed between systems.

### BACKGROUND OF THE INVENTION

The present invention relates to systems, computer-implemented methods and computer program products for integrating client-side logging information with a server-side logging system.

Asynchronous Javascript and XML (Ajax) is a Web development technique that is often utilized for creating interactive Web applications. With Ajax, the Model/View/Controller (MVC) is extended from the server to the browser where Javascript code may handle browser side programming logic. In practice, Ajax may be used to provide asynchronous communication between browsers and HTTP servers so that Web applications can exchange data with a corresponding server “behind the scenes”, and thus appear more responsive to the user. For example, Web pages built utilizing Ajax techniques may asynchronously make calls to an HTTP server to fetch small amounts of content and/or other relevant information, such as to update or modify the Document Object Model (DOM) of the associated HTML page, thus potentially avoiding the need to reload an entire Web page each time the user requests a change. As such, Ajax capability enables Web developers to deliver relatively rich Web-based applications in an efficient manner.

However, problem determination becomes a challenging issue for an Ajax-based application development and support. For example, if a client-side script does not work properly, a systems analyst on the server-side does not have integrated logging across the client and server for analyzing what has happened. Thus, a web developer that provides scripts for execution by web browsers does not have access to logs of activity information that would be useful in problem determination with regard to the execution of the script on the client systems hosting the web browsers. The systems analyst may not even know if the client-side application, e.g., a web browser, even attempted to execute the script. Moreover, existing client-side debugging, which is unavailable to the server-side systems analyst, may also often fail to capture useful information, such as when a browser crashes or other errors occur. Similar challenging issues are presented for other emerging technologies similar to Ajax where some amount of processing or activity is distributed, moved or executed or anticipated to be executed by a resource that is not readily monitored, such as an independently controlled and/or operated remote system.

### BRIEF SUMMARY OF THE INVENTION

According to an aspect of the present invention, an integrated logging system comprises a server-side logging component associated with a remote server that receives client-side logged activity information from at least one client-side processing device in response to data communication with the remote server, wherein the logged client-side activity information from each client-side processing device is asynchronously received by the server-side logging component and relates to the execution of a script within a client execution environment that is controlled and operated independently of the remote server. The integrated logging system also further comprises a server-side logging integration component that organizes server-side logged activity information and received client-side logged activity information into a server-side log, a storage system that stores the server-side log and an activity analysis component that conveys information from the server-side log to an analyst for problem determination with regard to script execution within the independently controlled and operated client execution environment.

According to another aspect of the present invention, a method for integrating logged activity information comprises providing a server-side logging component associated with a remote server that receives client-side logged activity information from at least one client-side processing device in response to data communication with the remote server, wherein the logged client-side activity information from each client-side processing device is asynchronously received by the server-side logging component and relates to the execution of a script within a client execution environment that is controlled and operated independently of the remote server. The method further comprises providing a server-side logging integration component that organizes server-side logged activity information and received client-side logged activity information into a server-side log, providing a storage system that stores the server-side log and providing an activity analysis component that conveys information from the server-side log to an analyst for problem determination with regard to script execution within the independently controlled and operated client execution environment.

According to yet another aspect of the present invention, a computer program product to implement an integrated logging system comprises a computer usable medium having computer usable program code embodied therewith. The computer usable program code comprises computer usable program code configured to implement a server-side logging component associated with a remote server that receives client-side logged activity information from at least one client-side processing device in response to data communication with the remote server, wherein the logged client-side activity information from each client-side processing device is asynchronously received by the server-side logging component and relates to the execution of a script within a client execution environment that is controlled and operated independently of the remote server. The computer program product further comprises computer usable program code configured to implement a server-side logging integration component that organizes server-side logged activity information and received client-side logged activity information into a server-side log that is stored in a a storage system and computer usable program code configured to implement an activity analysis component that conveys information from the server-side log to an analyst for problem determination with regard to script execution within the independently controlled and operated client execution environment.

### BRIEF DESCRIPTION OF THE SEVERAL VIEWS OF THE DRAWINGS

FIG. 1 is a schematic illustration of an exemplary system in which integrated logging may be performed;

FIG. 2 is a flow chart illustrating a method of integrating logged activity information according to an aspect of the present invention;

FIG. 3 is a block diagram illustrating an exemplary system for integrated logging according to an aspect of the present invention; and

FIG. 4 is a block diagram illustrating an exemplary system for integrated logging according to another aspect of the present invention.

### DETAILED DESCRIPTION OF THE INVENTION

The various aspects of the present invention may be embodied as systems, computer-implemented methods and computer program products. Also, various aspects of the present invention may take the form of an entirely hardware embodiment, an entirely software embodiment (including firmware, resident software, micro-code, etc.) or an embodiment combining software and hardware, wherein the embodiment or aspects thereof may be generally referred to as a “circuit,” “component” or “system.” Furthermore, the various aspects of the present invention may take the form of a computer program product on a computer-usable storage medium having computer-usable program code embodied in the medium.

The software aspects of the present invention may be stored, implemented and/or distributed on any suitable computer usable or computer readable medium(s), including but not limited to, any medium that can contain, store, communicate, propagate or transport the program for use by or in connection with an instruction execution system of a corresponding processing device. The computer program product aspects of the present invention may have computer usable or computer readable program code portions thereof, which are stored together or distributed, either spatially or temporally across one or more devices. A computer-usable or computer-readable medium may comprise, for example, an electronic, magnetic, optical, electromagnetic, infrared, or semiconductor system, apparatus, device, or propagation medium. As yet further examples, a computer usable or computer readable medium may comprise cache or other memory in a network processing device or group of networked processing devices such that one or more processing devices stores at least a portion of the computer program product. The computer-usable or computer-readable medium may also comprise a computer network itself as the computer program product moves from buffer to buffer propagating through the network. As such, any physical memory associated with part of a network or network component can constitute a computer readable medium.

More specific examples of the computer usable or computer readable medium comprise for example, an electrical connection having one or more wires, a swappable intermediate storage medium such as floppy drive, tape drive, external hard drive, a portable computer diskette, a hard disk, a random access memory (RAM), a read-only memory (ROM), an erasable programmable read-only memory (EPROM or Flash memory), a portable compact disc read-only memory (CD-ROM) or digital video disk (DVD), an optical fiber or storage device, or a transmission media such as those supporting the Internet or an intranet. The computer-usable or computer-readable medium may also comprise paper or another suitable medium upon which the program is printed or otherwise encoded, as the program can be captured, for example, via optical scanning of the program on the paper or other medium, then compiled, interpreted, or otherwise processed in a suitable manner, if necessary, and then stored in a computer memory. The computer-usable medium may include a propagated data signal with the computer-usable program code embodied therewith, either in baseband or as part of a carrier wave or a carrier signal. The computer usable program code may also be transmitted using any appropriate medium, including but not limited to the Internet, wire line, wireless, optical fiber cable, RF, etc.

Computer program code for carrying out operations of the present invention may be written in any suitable language, including for example, an object oriented programming language such as Java, Smalltalk, C++ or the like. The computer program code for carrying out operations of the present invention may also be written in conventional procedural programming languages, such as the “C” programming language, or in higher or lower level programming languages. The program code may execute entirely on a single processing device, partly on one or more different processing devices, as a stand-alone software package or as part of a larger system, partly on a local processing device and partly on a remote processing device or entirely on the remote processing device. In the latter scenario, the remote processing device may be connected to the local processing device through a network such as a local area network (LAN) or a wide area network (WAN), or the connection may be made to an external processing device, for example, through the Internet using an Internet Service Provider.

According to an aspect of the present invention, an integrated logging system is provided, which includes a client-side logging component and a server-side logging component. The client-side logging component possesses the capability of logging activity information, such as may relate to the execution of a script or other suitable client-side code. For example, the client-side logging component may create a temporary client-side logging instance to log activity information related to a corresponding remote script execution instance.

The client-side logging component may also communicate logged activity information back to a corresponding server in a manner that may be implemented independently of specific activity within a local container, e.g., a Web-browser from which activity information is logged. Thus, for example, logged activity information may be communicated back to a corresponding server despite events such as where a Javascript execution error occurs, where a user leaves the current local container instance to implement a different activity, when an execution error causes the container to crash, the associated server fails to respond, etc.

Messages including logged client-side activity information are received from the client-side logging component by the server-side logging component, and the logged activity information is integrated into the server-side log(s) of a server-side logging system. Thus, activity information, which may be used, for example for problem determination, is integrated from sources that are distributed between systems, even where the client-side systems are independently controlled and operated.

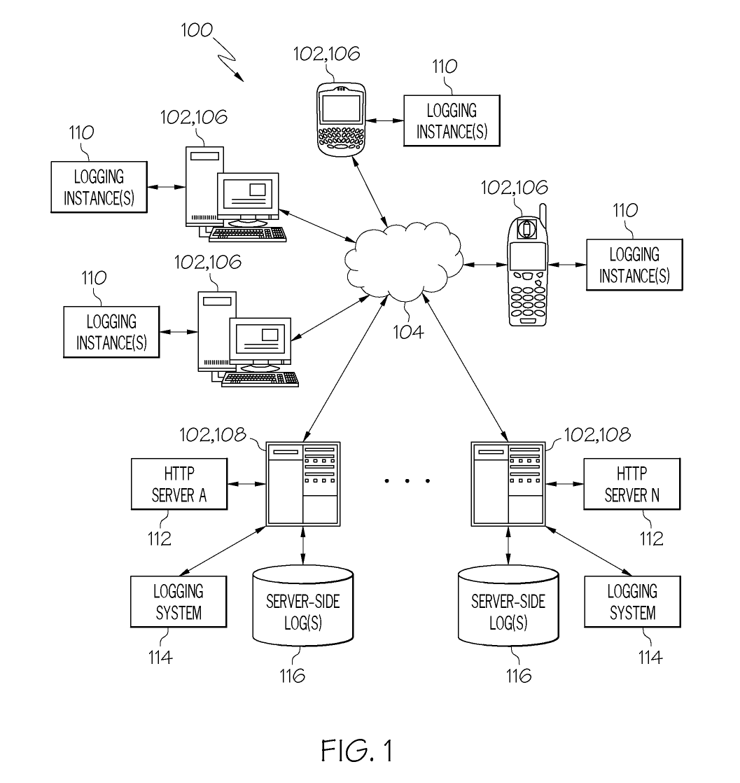

Referring now to the drawings and particularly to FIG. 1, an exemplary system 100 is illustrated in which an integrated logging system may be implemented according to aspects of the present invention. The system 100 includes a plurality of processing devices 102 that communicate across a network system 104. The processing devices 102 may comprise for example, servers, personal computers, notebook computers, transactional systems, appliance or pervasive computing devices such as personal data assistants (PDA), palm computers, cellular access processing devices, special purpose computing devices and/or other devices capable of interacting with the system 100, and may thus be implemented in hardware, software, or a combination of hardware and software.

The various processing devices 102 may be supported by networking components such as routers, hubs, firewalls, network interfaces, wired or wireless communications links and corresponding interconnections. Moreover, the network system 104 may comprise one or more intranets, extranets, local area networks (LAN), wide area networks (WAN), wireless networks (WIFI), the Internet, including the World Wide Web, and/or other arrangements for enabling communication between the processing devices 102, either real time or otherwise, e.g., via time shifting, batch processing, etc.

Selected ones of the processing devices 102, further designated by the reference numeral 106, may execute one or more instances of a graphics user interface (GUI) container that is capable of data communication with one or more remote processing devices 102, which are correspondingly further designated by the reference numeral 108. As typical communication between a GUI container and a remote processing device is conceptualized as a client-server relationship, the processing devices 106 are also referred to herein as client-side processing devices 106 and the processing devices 108 are also referred to herein as remote processing devices 108 or server-side processing devices 108.

The terms “client-side” and “server-side” should be interpreted expansively and are used herein to clearly distinguish and describe the relationship between two processing devices 102 and/or computer programs executed on two processing devices 102 in which one program, designated the client, makes a request for information, e.g., a service request, from another program, designated the server, which fulfills the request. Further, the client-side processing device 106 hosts or is otherwise associated with a client execution environment that is controlled and operated independently of a corresponding remote server that fulfills the request.

In an illustrative example, an instance of a GUI container may comprise an application such as a Web browser or other component that is capable of hosting a script that has been downloaded or otherwise received from a remote server, where execution of the script orchestrates interaction with back-end services, such as may be provided on a server-side processing device 108. A suitable script may include, by way of example, a script compatible with the Javascript scripting language.

Correspondingly, the back-end services of the remote processing devices 108 may be implemented, for example, as a Hypertext Transfer Protocol (HTTP) server or other server or processing device that is capable of communication with a compatible GUI container.

Keeping with the above example, in a conventional Internet browsing exchange, a GUI container instance, e.g., a Web browser executing on a client-side processing device 106 interacts with a back end service such as a Web server executed on a server-side processing device 108 by initiating a request for server content. Upon receiving a request for content, the Web server responds back to the Web browser with a page comprising markup language information. The Web browser uses the page including the markup language received from the Web server to render the page into a formatted display, which is displayed on a display of the client-side processing device 106.

In the process of rendering and displaying the Web page, the Web browser may be required to fetch images and other information, such as from one or more additional Web servers or other Internet enabled devices. However, the page returned to the web page does not typically include or otherwise link to executable code that is to be executed by the client-side processing device 106. Executable code is typically carried out on the Web server itself. Accordingly in the event that an error occurs, a program developer may consult the server log entries to try to identify the root cause of the problem that led to the error condition.

However, emerging Internet-based technologies, such as Ajax, are enabling the client-side execution of programs. For example, certain Web based technologies such as JavaScript allow applications to be executed on a client-side processing device 106 as part of a Web page rendering operation. The programs may be used to assist in formatting the rendered page, to interact with the user, e.g., to obtain information and/or to provide other types of functionality. However, a server-side applications programmer, systems analyst, etc., does not have visibility of activity information, such as events corresponding to the execution of programs including scripts on the client side.

According to aspects of the present invention, the client-side processing devices 106 may each comprise a client-side logging component that executes one or more logging instances 110, e.g., where each logging instance may correspond to an instance of a GUI container executed on the client-side processing device 106. The logging instances 110 record activity information, such as may be related to scripts executed by an associated GUI container during a rendering or other operation as a result of communication with a corresponding server. Moreover, the logged activity data may be communicated back to an associate server-side processing device 108, such as may be executing an HTTP server application 112 and/or a suitable server-side logging system 114.

The server-side processing devices 108 are each associated with a server-side logging system 114 that collects and logs server-side activity information. The log information is stored in one or more log files 116, such as may be located in any convenient storage arrangement. Various exemplary configurations for integrated logging will be described in greater detail below.

The logging instances 110, the logging system 114 and the server-side log(s) 116 are each schematically illustrated as being associated with a single processing device 102, but each may reside anywhere practical, e.g., either physically on the processing device 102 or distributed across one or more devices 102 that can be brought into data communication with the associated client-side processing device 106 or server-side processing device 108, such as across the network system 104.

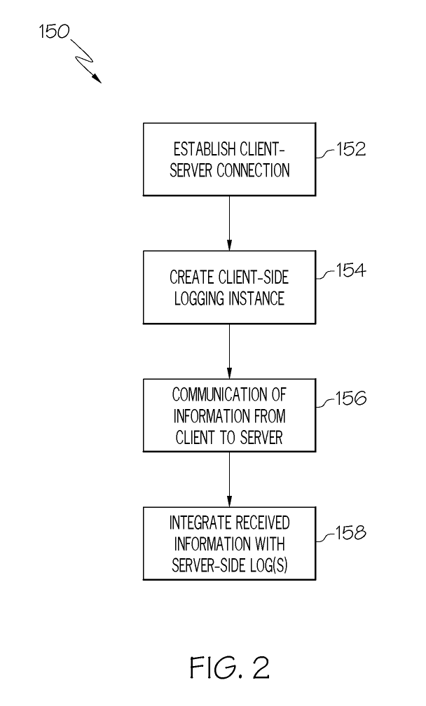

Referring to FIG. 2, a method 150 is illustrated for providing integrated and/or unified logging of activities, such as for logging of activities related to a remote script execution instance. For example, the integrated logging may be utilized to log events associated with an Ajax enabled Web application, such as to facilitate problem determination by communicating client-side activity information related to operation of a remote script execution instance.

A client-server connection is established at 152, such as by a Web browser or other suitable GUI container on a client-side processing device 106, initiating a session with an HTTP server, such as an HTTP server 112 executing on a server-side processing device 108. In response to the client-server connection, a client-side logging instance is created at 154. The client-side logging instance temporarily stores, e.g., in a non-volatile memory associated with the client-side processing device 106, activity information, such as events and other information that may be useful in debugging errors associated with scripts and other/or other executable applications executed by the client-side processing device 106. For example, where a GUI container comprises a Web browser, the client-side logging instance may log activity information relating to the rendering of a Web page associated with a corresponding HTTP server 112. The client-side logging instance may be temporary, e.g., such as may be created upon detecting that a script is to be executed as part of the execution of the GUI container where debugging or other verification of the script is desired or required by a remote entity, such as a systems analyst responsible for the HTTP server 112 and corresponding server-side processing device 108.

The client-side logging component possesses the capability of communicating messages comprising logged activity information with the associated HTTP server at 156, and the communicated activity information is integrated with the corresponding server-side logs at 158. As such, the log information can be merged in such a way that problem resolution knowledge is available to an applications developer, programmer, systems analyst or other support person on the server-side in the manner such that the log information reflects knowledge of the status of script execution on the client side.

The communication of events at 156 may be implemented independent of the active status of the corresponding GUI container. Thus, the method 150 may be implemented in a way that preserves client-side log entries, even when the client-side container or the corresponding server crashes. As such, if the container, e.g., Web browser, is closed or otherwise exited, the logged event information may still be communicated. Moreover, the communication of events at 156 may be performed independent of maintenance of an active communication between the GUI container and corresponding remote server. For example, if data communication is broken, the logged activity information may remain stored in a non-volatile storage location accessible to the corresponding client-side processing system 106. Upon the re-establishment of data communication between the GUI container and corresponding remote server, the contents of the client-side storage can be communicated to the remote server.

As some illustrative examples, if the local container comprises a Web browser that is executing a Javascript and the Web browser experiences an error, such as a Javascript execution error, the client-side logging instance log events associated with the error, even if the error causes the corresponding Web browser to crash. As further examples, the client-side logging instance may be able to complete transactions regardless of whether a corresponding user leaves the current local container instance, e.g., the user leaves the graphical user interface (GUI) instance to engage in a different activity. Moreover, a client-side logging instance can continue to collect and log activity information with regard to script execution even when the corresponding server fails to respond to a request from the Web browser.

The logged activity information is formatted in to messages that are communicated to the server side at 156, where they are integrated in a unified way with the server side log(s) at 158. Accordingly, a temporary client-side logging instance is provided for activity such as a remote script execution instance. As the logged activity information is integrated with other server information at the server-side, flexibility is provided that is not otherwise realizable with a traditional client-side log which may or may not exist on a given system, and which is traditionally unavailable to server-side 108 if it exists. With reference to FIGS. 1 and 2 generally, the system 100 and/or method 150 enable the distribution of activity logging and the integration of logged information.

According to an aspect of the present invention, the integrated logging system, e.g., as shown in FIG. 1, may be configured to be turned on or off and/or the integrated logging system may be set to different logging levels, such as info, warn, debug, error, etc. Moreover, not all server-side logging systems will require log information from a client. For example, if interaction between a client and a server does not require the execution of a script or other program, or if there is no desire to track client-side activity in a server-side logging system, then the client-side logging instance 110 may be turned off or otherwise not created.

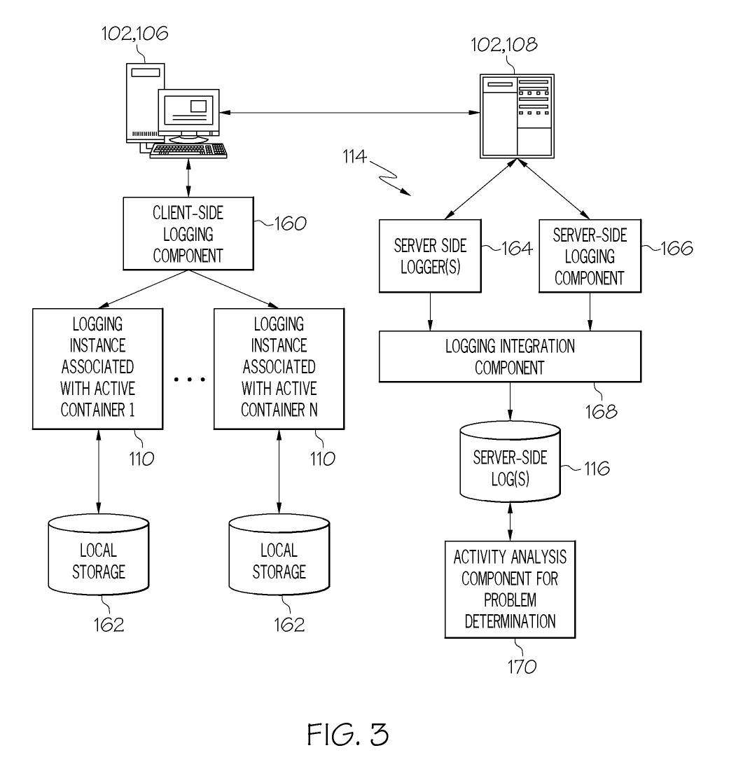

Referring to FIG. 3, according to an aspect of the present invention, a client-side logging component 160 may be installed onto one or more client-side processing devices 106. The client-side logging component 160 creates a logging instance 110 on the corresponding processing device 106 for each instance of a local container where it is desired to track client-side events. The creation of a logging instance 110 may be based, for example, upon a command received from the local container, e.g., in response to the corresponding server requesting log information, upon recognition of a script to be executed by the client-side processing device 106 or other suitable manner.

A container instance may comprise an occurrence of a client-server connection. For example, where the local container comprises a Web browser that supports tabs, there may be multiple local container instances associated with a single Web browser application, such as one local container for each tab. Moreover, a client processing device 106 may execute multiple applications that each execute one or more local containers, such as by opening multiple copies of an application onto a desktop.

The client-side logged activity information is stored in a suitable local storage 162. The local storage 162 may comprise, for example, non-volatile memory that is accessible by the corresponding client processing device 106. The local storage 162 may be stored separately for each logging instance 110, or the various log information may be stored in a common storage format accessible by the client processing device 106, an example of which shall be described in greater detail herein.

From time to time, the client-side logging component 106 will communicate logged client-side activity information to a corresponding server. As noted above, the server-side processing device 108 may also have, or be capable of communication with, a logging system 114. The logging system 114 may include server side logger(s) 164 that store activity information, such as collected events associated with various types of server-side activity information into one or more server-side logs 116.

The logging system 114 also includes a server-side logging component 166. The server-side logging component 166 may be utilized to handle communication between the server-side and client side processes. The server-side logging component 166 performs logging manager functions, but does not need not be physically stored on the server-side processing device 108, e.g., so long as suitable data communication is achieved. For example, the server-side logging component 166 may perform functions such as receiving logged activity information from client processing devices 106, each having a Web browser interacting with a corresponding HTTP Web server hosted by an associated server-side processing device 108, etc.

A logging integration component 168 may also be provided on the server-side processing device 108. The logging integration component 168 may be utilized to store client-side activity information received by the associated server-side logging component 166. The logging integration component 168 may also merge, organize, sort, coalesce, aggregate or otherwise manipulate the logged activity information from the server-side loggers 164 and/or the client side activity information received by the server-side logging component 166. For example, as will be described in greater detail below, the client-side logged activity information may not be communicated to the associated server-side logging component in real or near real time. As such, the logging integration component 168 may position the new client-side activity at some location within the server-side logs 116 in a manner other than merely appending the activity information to the end of the file, such as to properly chronologically characterize the received activity information. An example of merging logged activity information is described in greater detail below.

An activity analysis component 170 may interact with the merged logged activity information for problem determination. For example, a human or automated process that is responsible for debugging and discovering a root cause of a problem may consult the server-side log(s) 116 and have visibility to activities occurring both on the server side and client side.

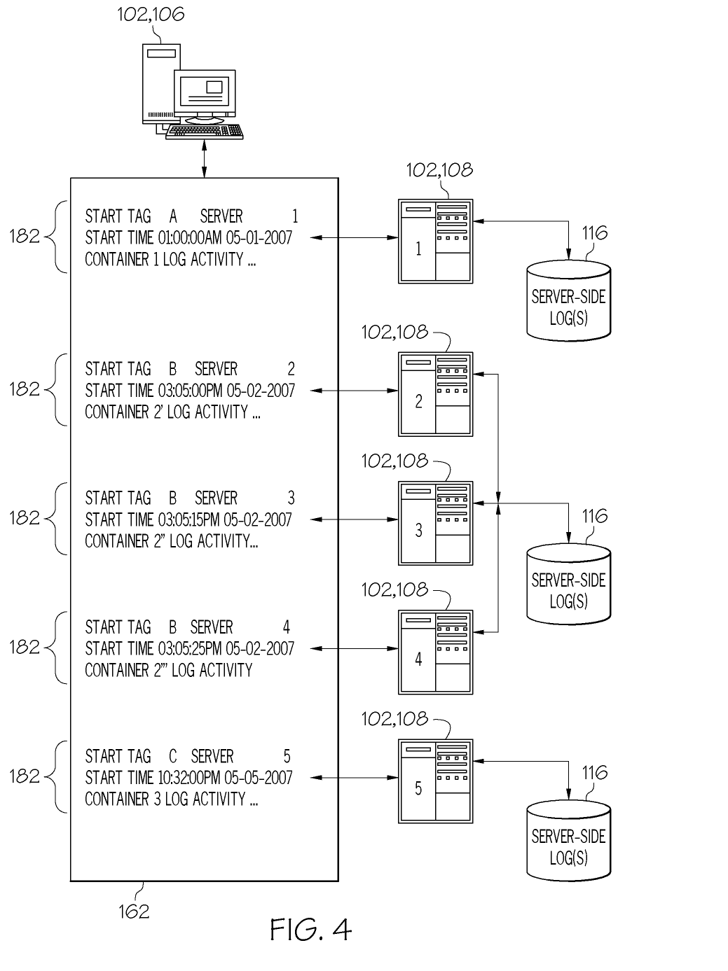

Referring to FIG. 4, as noted in greater detail herein, a client-side processing device 106 may simultaneously be executing multiple logging instances 110. Each logging instance 110 may relate to the same remote server that desires logging, e.g., by having two or more tabs of a browser pointing to the same page, or by having multiple instances of a Web browser pointing to a common page. Moreover, the various logging instances 110 may be related to different remote servers, e.g., different Web pages, which may be independent of each other, e.g., controlled by different entities, deployed as part of different business enterprises, etc. Conversely, each server can request logging information from multiple client-side logging instances 110 across multiple client-side processing devices 106.

According to an aspect of the present invention, each time a remote server requests that a corresponding container instance tracks and sends back log information, the remote server, e.g., via the server-side logging component 166, may send a marker 182 to the corresponding client container. Each marker 182 may comprise, for example, a start tag and optionally, a unique identifier. The start tag may, for instance, comprise a unique value that identifies the start of a particular session. The identifier identifies the corresponding remote server, e.g., by using an address of the corresponding server. For example, the identifier may comprise the server's uniform resource identifier (URI). The use of a start tag and optional server identification provides an exemplary way to synchronize the activity on the client and server systems, and further provides a way to organize logged client-side activity information at both the client side and the server side.

Additionally, each marker 182 may include a server-side timestamp, e.g., as part of the start tag and/or identifier or in addition to the start tag and identifier. The server timestamp may be useful, for example, when merging client-side activity information with server side activity information to ensure that the merged information is properly time synchronized. This information further allows, for example, a convenient manner of locating and storing activity information at the client-side, e.g., in a local log data set stored in the local storage 162.

This makes it easy for the client log service, e.g., the client-side logging component to integrate logged activity information associated with several (likely unrelated) servers into a common local storage format at local storage 162. The use of the marker 182 also allows client-side logged activity information from one or more client-side processing devices 106 to be readily integrated with log(s) in a server-side log system 114.

According to an aspect of the present invention, the server-side logging component 166 may create a new marker 182, such as when execution shifts to a client container, e.g., a browser. Moreover, the server side logging component 166 may also create an end tag, such as when execution returns from the client container to the server.

As a few additional illustrative examples, the server-side logging component 166 may communicate a marker 182 to a corresponding client-side logging component 160 upon an initial communication from a corresponding Web browser or other page instance. For example, the server knows it is sending information back to the client that will require the client to execute code, so the server may anticipate that the client will in fact execute the code and send the marker 182. However, the server may not have a guarantee that the client will actually execute the code. For example, certain Web browsers allow the user to disable script execution. Alternatively, the server can infer that the Web browser is executing the script if information is being exchanged between the client-side component 160 and the server-side component 166 that is indicative of script execution.

As another example, the server-side logging component 166 may communicate a marker 182 to a corresponding client-side component 160 when a Web page requests information that is associated with a script. As yet another example, the marker 182 may be embedded in the information returned from the server to the Web browser, such as by embedding the marker 182 into the text describing the page, or in the script or other executable that the client is intended to execute. As yet another illustrative example, the communication of a marker 182 can be integrated into a script execution, such as a JavaScript execution. Under this arrangement, when the script begins executing, it could start by requesting that the server-side logging component 166 communicate a marker 182 to the client-side logging component 164.

As an illustrative example, as shown in FIG. 4, assume that a client-side processing device 106 has multiple active GUI container instances, e.g., tabs in a Web browser that are collectively interacting with five different HTTP servers, shown for purposes of illustration as five server-side processing devices 108, labeled 1-5.

For example, assume a first GUI container instance, e.g., a first Web browser instance is in communication with an HTTP server on Server 1. Further, assume that the first Web browser is to execute a script and that Server 1 wants to receive log information with regard to script execution. Server 1 sends a first marker 182 to the client-side processing device 106, which includes a unique start tag, identifier and timestamp. As shown, the start tag has the unique value A and identifier 1, such as may correspond to the uniform resource identifier (URI) of the server-side logging component 166 associated with the first HTTP server. In response, the client-side logging component 164 may create a first logging instance 110 that is associated with the start tag and identification of Server 1.

The first logging instance 110 collects and logs activity information in the local storage 162 with regard to the execution of a script within a client execution environment associated with the first Web browser/first HTTP server interaction. The logged activity information is uniquely identified in the local storage 162, such as by indexing, keying or otherwise organizing the logged activity information to the first marker. As will be described in greater detail below, at some point, the logged activity information is asynchronously received by the server-side logging component 166 so that the server-side log 116 includes logged activity information with regard to script execution that occurred on a client-side processing device 106, which is controlled and operated independently of the remote server, e.g., the first HTTP server.

Next, assume that a second container instance, e.g., a second Web browser in another tab, another window, etc., of an application contacts Server 2, which is independent of Server 1. The Web page associated with Server 2 may be deployed by a large business enterprise. Thus, the second Web browser may be required to fetch information, e.g., scripts, programs, multimedia, style sheets, and other information from Servers 2-4. As such, Servers 2-4 are each associated with the display of the same Web page on the second Web server. In an illustrative example, only one logging instance 110 is utilized to temporarily store the logged activity information, regardless of the number of servers that the second web page is required to interact with, as there is a one to one correspondence of logging instances to web page instances. However, other arrangements may be implemented. Further, the log information from the Servers 2, 3, and 4 are separately identifiable in the client-side temporary logs in the local storage 162, e.g., by the unique server identification and optionally, the timestamp. Thus, as shown, logged activity information associated with Server 2 is designated as container 2′ log activity for purposes of illustration. Similarly, logged activity information associated with Server 3 is designated as container 2″ log activity and logged activity information associated with Server 4 is designated as container 2′″ log activity.

As one illustrative example, Server 2 may generate a second marker 182. As shown, the marker 182 associated with server 2 includes a start tag, e.g., B, which is distributed not only to the client-side processing device 106, but also the Servers 3-4. Accordingly, when Servers 3 and 4 are contacted by the client-side processing device 106, they each respond with a marker 182 bearing the same start tag B. As such, logged activity information across multiple server-side processes, even from different physical devices, as well as across client-side processing device(s) can be integrated at the server side log(s) 116. For example, a systems analyst trying to identify the root cause of a problem on a large, distributed enterprise system may utilize the activity analysis component 170 to quickly identify logged activity information across multiple physical server-side devices and logged activity from the client-side processing device simply by querying the server-side log(s), e.g., for activity information associated with a tag of interest, e.g., tag B. The analyst can also readily identify the source of the logged activity information within the tag of interest, e.g., tag B, because each processing device, e.g., each server and the client-side processing device is uniquely identified in the server-side log(s) 116.

Alternatively, each Server 2-4 may have responded the client-side processing device with a marker 182 having a unique start tag leaving the job to the server side logging component 166 and/or the logging integration component 168 to sort out merging, such as by maintaining cross reference lists, etc.

Further, as shown, server 5 has communicated a marker 182 that includes a start tag having the value 5 and a server identification of Server 5 to the client-side processing device 106.

From time to time, e.g., asynchronously, the client-side processing device 106, e.g., via the client-side logging component 164, may communicate logged activity information to the corresponding server 108. For example, a client-side activity log message or messages may be sent back to the corresponding server(s) whenever a triggering change is detected, e.g., the client browser execution context is changed. Examples of client browser execution context changes may include, for example, a form submission to the server requesting a new Web page, an Ajax call to the server for data exchange, a user leaves the current page for another Web site, and a Javascript exception is thrown that halts the Javascript execution. Moreover, additional examples of when the logged client activity information may be sent back to the corresponding server may include, for example, when the browser is restarted after a crash or when the network connectivity is re-established. The client side log can be brought back to the server in the background, for example through browser Ajax calls.

As a specific example, upon an exit such as when the tab is killed or a window is closed, Javascript receives a page unload message. In response to receiving a page unload message, the client-side logging component 160 may transfer log information back to the corresponding server-side logging component for each associated server. If the connection crashes, or if the browser dies, the next time that the browsers brought back up and brought into communication with the corresponding server, the existing entries stored in the client-side log may be flushed and the system may begin to start logging new entries as described more fully herein.

Upon successfully transmitting log information to the corresponding server 108, the transmitted log activity information can be deleted from the local storage 162. Successful transmission of logged activity information may be determined, for example, by the client-side logging component 164 receiving a log message receipt confirmation from the corresponding server. As an example, the local storage 162 can be searched and all log entries associated with a particular marker 182 can be retrieved. The marker 182 identifies the server to send the log information back to. Also, the marker 182 is returned to the server so that the server knows where in the server logs to merge the received activity information. In this regard, the server that sent the marker 182 also knows the client's identity, at least by virtue of knowing where it sent the marker 182 and the server knows from where a marker 182 was received.

Moreover, as noted in greater detail above, it is possible that errors may occur, e.g., an executed script may crash, a user may intentionally or inadvertently close the active window or tab, a server connection may be temporarily disabled, etc. Accordingly, when a container instance receives a start tag from a server for which outstanding log activity group entries exist in the local storage 162, the logging service, e.g., via the client-side logging component may transmit the previously recorded log activity information, e.g., in the background, and remove them from the client-side local storage 162. Again the client-side logging component 164 may require a log message receipt confirmation from the corresponding server 108 before deleting the log entries from the local storage 162. This same recovery process may automatically occur each time the container is started.

The above was presented by way of illustration and not by way of limitation of an exemplary way to communicate synchronization information between a corresponding client and server. Other types of messages and techniques may alternatively be implemented. Also, the logged activity information for each instance may be stored on the client-side processing device 106 in a common data source or as individual data sources.

When the client-side log for a given window or tab activity (remote script execution instance) is brought back to a server, it is merged with the server-side log(s) 116. The server-side logging component 166 may also generate an “end client-side activity log” tag, such as to designate the end of client-side activity information in the server-side log(s) 116. Any log merging or other manipulations may be performed using any number of suitable techniques. For example, the logged client-side activity information can simply be added to the end of the server-side log(s) 116 as a single chunk, or the logged client-side activity information can be inserted into the server-side log(s) based on a timestamp, such as may have been provided in the corresponding marker 182.

The time on a client system may not be the same as the time stamp recorded by the server-side logging system. Accordingly, time synchronization may be deployed. One exemplary approach is to relate all client-side logging activity information relative to the corresponding marker 182. Thus the time and date on the client-side logging activity may be offset or otherwise manipulated, such as at the server-side logging system 114, so that the time of events are synchronized. For example, an offset for each logged activity can be added to the timestamp time, either at the client side or server side. For example, assuming that transmission delays are small to negligible, the offset may be determined based upon the time between receipt of the marker 182 or some other reasonable measure, and the time each log entry is created.

According to an aspect of the present invention, the server side data logging system is capable of relating logged activity information from various client-side logging instances. For example, entries from the client-side logging instance may not be communicated to the server-side logging system in real-time or near real time. As such, the server places a copy of the marker 182, the start tag from the marker 182 or other placeholder into its server-side logging system. The marker 182 is also supplied to the client-side logging instance 110. Under this arrangement, client-side logged activity information can be tied back in to the placeholder previously recorded in the server-side logging system 114 to identify where the client-side logged activity information should be merged in with the server-side logged activity information in the server-side log(s) 116.

As such, the server-side log(s) 116 include not only server-side activity but activities that correspond to what is going on inside an associated, but independently controlled and operated remote GUI container instance. Accordingly, the marker 182 can be implemented using any suitable technique that allows the server-side logging system 114 to link or otherwise associate client-side logged activity information with corresponding server-side logged activity information.

According to an aspect of the present invention, a triggering event may be utilized to cause a client-side component 160 to submit back to a corresponding server-side component 166, and end tag or other identifier that indicates to the server that the page instance is no longer active. For example, when a user exits a page or closes down a Web browser, the corresponding client-side logging instance 110 may communicate back to its server an end tag or other information that allows the server to know that a session has ended.

Certain scripting code such as Ajax can be utilized to request information and to pass information back and forth between the client and the server in the background. As small pieces of information are asynchronously transferred back and forth, the perception of a more fluid Web page results because entire page reloads may not be necessary upon updates. Such scripts may be identified by including pointers in the Web page code that is returned back to the Web browser in a manner analogous to that used to link to images etc. For example a pointer in the Web page code may identify a location on the current server or a different server where to fetch the Javascript code. Alternatively, the JavaScript may be buried in the Webpage code, such as by including the JavaScript in a script block.

The client-side logging instance 110 may be implemented by creating an active support device accessible from the associated container. For example, a Web browser may utilize a plug-in type format to support the client-side logging instance 110. As another example, a client-side logging instance 110 may be deployed utilizing active X or Adobe plug-in style of formats. Thus when a Web page is rendered, the plug-in or other suitably formatted markup will invoke the client-side scripting instance code.

Thus for example using existing technologies such as with plug-in instances, if a Web browser does not include the logging instance application upon the first time that the Web browser connects to a Webpage that supports client-side logging, a dialog box or other suitable message may prompt the user so that the user can elect to load an install the plug-in. The user may also be notified when entering or exiting a page that a client-side logging application is available, and appropriate links may be provided so that the user can download and install the client-side component 160. In this regard, although the client-side processing device 108 is shown as having a client-side logging component 160 and a client-side logging instance 110 in the figures, the functions, actions and roles provided by each may be implemented in practice in any practical manner, including integration into a single application.

The client-side logging instance 110 may support generic logging wherein script execution activity is monitored and logged. Alternatively the executed script itself may capture key information for the client-side log. For example the developer of the script may take responsibility to ensure that the script suitably logs information that may be useful for debugging purposes. Accordingly, the script itself may suggest or otherwise identify events and other activity information that are to be logged.

The server-side logging system 114 and the client-side logging component 160 may accumulate normal chatter back and forth during execution. However, if nothing unusual happens in the execution of the script or other activity being monitored by the client-side logging system, then a decision may be made as to whether or not logged activity information should be delivered to the server-side logging system 114.

The client-side logging component 160 may determine whether or not it wants to submit log information to the corresponding server-side logging component. For example, during routine script execution, an associated client-side logging instance 110 may recognize and logged numerous activities. However, if the script terminates successfully or uneventfully, there may be no reason to submit all of the normal evidence to the server-side logging service. However, if the client-side scripting instance detects an unusual or otherwise event activity of interest, then the client-side logging instance may submit appropriately marked log activity information to the server-side logging system 114.

Accordingly, even where script instance logging is desired, a normal exit of a page may not generate log data at the server-side. As noted above, the client-side logging component 160 may decide to throw away logged activity information because the page closed normally and no recorded activity was suggestive of information of interest to the server-side logging system 114. However, the client-side logging component 160 may communicate to the server-side logging component 160 that a script completed successfully, or that a page closed or exited without incident. The confirmation message may also include a timestamp or other relevant information. The server-side component 166 may respond to the client-side component 160 acknowledging that everything was okay on the client-side, which may trigger the client-side component 160 to flush the relevant logged activity information recorded for that page instance.

Moreover, the client-side component 160 may communicate logged activity information to a server-side component 166 and the server-side component 166 may decide whether to store the received information in the server-side log(s) 114 or whether to throw the received information away. That way, numerous items of the information can be suppressed that are not relevant to the server-side.

The present invention is described with reference to flowchart illustrations and/or block diagrams of methods, apparatus systems and computer program products according to embodiments of the invention. It will be understood that each block of the flowchart illustrations and/or block diagrams, and combinations of blocks in the flowchart illustrations and/or block diagrams may be implemented by system components or computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention may be practiced on any form of computer system, including a stand alone computer or one or more processors participating on a distributed network of computers. Thus, computer systems programmed with instructions embodying the methods and/or systems disclosed herein, or computer systems programmed to perform various aspects of the present invention and storage or storing media that store computer readable instructions for converting a general purpose computer into a system based upon the various aspects of the present invention disclosed herein, are also considered to be within the scope of the present invention. Once a computer is programmed to implement the various aspects of the present invention, including the methods of use as set out herein, such computer in effect, becomes a special purpose computer particular to the methods and program structures of this invention. The techniques necessary for this are well known to those skilled in the art of computer systems.

The flowchart and block diagrams in the Figures illustrate the architecture, functionality, and operation of possible implementations of systems, methods and computer program products according to various embodiments of the present invention. In this regard, one or more blocks in the flowchart or block diagrams may represent a component, segment, or portion of code, which comprises one or more executable instructions for implementing the specified logical function(s). In some alternative implementations, the functions noted in the blocks may occur out of the order noted in the figures. For example, two blocks shown in succession may, in fact, be executed substantially concurrently or in the reverse order.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

Having thus described the invention of the present application in detail and by reference to embodiments thereof, it will be apparent that modifications and variations are possible without departing from the scope of the invention defined in the appended claims.

What is claimed is:

1. An integrated logging system comprising:
a server-side logging component associated with a remote server that receives client-side logged activity information from at least one client-side processing device in response to data communication with said remote server, wherein said logged client-side activity information from each client-side processing device is asynchronously received by said server-side logging component and relates to the execution of a script within a client execution environment that is controlled and operated independently of said remote server;
a server-side logging integration component that organizes server-side logged activity information and received client-side logged activity information into a server-side log;
a storage system that stores said server-side log; and
an activity analysis component that conveys information from said server-side log to an analyst for problem determination with regard to script execution within said independently controlled and operated client execution environment.

2. The system according to claim 1, wherein said server-side logging component transmits a marker to a client-side logging component associated with each client-side processing device, said marker comprising at least a start tag and server identification, wherein said marker is returned to said server-side logging component with said client-side logged activity received from each client-side processing device.

3. The system according to claim 2, wherein said marker further comprises a time stamp and said server-side logging integration component merges said logged client-side activity information in an appropriate time sequence with corresponding server-side activity information in said server-side log.

4. The system according to claim 3, wherein said received client-side logged activity information is stored in said server-side log by computing an offset of each activity based upon said timestamp.

5. The system according to claim 2, wherein:
said server-side logging component further communicates said start tag to one or more additional related servers for distribution from each server to a corresponding one client-side processing device.

6. The system according to claim 2, wherein:
said server-side logging component transmits a different marker to said client-side logging component for each client-side logging instance executing in said client execution environment of a corresponding processing device.

7. The system according to claim 1, wherein said server-side logging component transmits a receipt confirmation to a corresponding client-side logging component, so that logged activity information that is locally stored on a corresponding client-side processing device that has been acknowledged by said receipt confirmation is removed from a non-volatile storage associated with said client-side processing device.

8. A method for integrating logged activity information comprising:
providing a server-side logging component associated with a remote server that receives client-side logged activity information from at least one client-side processing device in response to data communication with said remote server, wherein said logged client-side activity information from each client-side processing device is asynchronously received by said server-side logging component and relates to the execution of a script within a client execution environment that is controlled and operated independently of said remote server;
providing a server-side logging integration component that organizes server-side logged activity information and received client-side logged activity information into a server-side log;
providing a storage system that stores said server-side log; and
providing an activity analysis component that conveys information from said server-side log to an analyst for problem determination with regard to script execution within said independently controlled and operated client execution environment.

9. The method according to claim 8, wherein said providing a server-side logging component associated with a remote server that receives client-side logged activity information from at least one client-side processing device in response to data communication with said remote server comprises:
providing a server-side logging component that transmits a marker to a client-side logging component associated with each client-side processing device, said marker comprising at least a start tag and server identification, wherein said marker is returned to said server-side logging component with said client-side logged activity received from each client-side processing device.

10. The method according to claim 9, wherein:
said providing a server-side logging component that transmits a marker to a client-side logging component associated with each client-side processing device further comprises:
providing a server-side logging component that transmits a time stamp as part of said marker; and
said providing a server-side logging integration component that organizes server-side logged activity information and received client-side logged activity information into a server-side log further comprises:
providing a server-side log that merges said logged client-side activity information in an appropriate time sequence with corresponding server-side activity information in said server-side log by said server-side logging integration component.

11. The method according to claim 10, wherein said providing a storage system that stores said server-side log further comprises:
providing a storage system that stores said received client-side logged activity information in said server-side log by computing an offset of each activity based upon said timestamp.

12. The method according to claim 9, wherein said providing a server-side logging component associated with a remote server that receives client-side logged activity information from at least one client-side processing device in response to data communication with said remote server further comprises:
providing a server-side logging component that communicates said start tag to one or more additional related servers for distribution from each server to a corresponding one client-side processing device.

13. The method according to claim 9, wherein said providing a server-side logging component associated with a remote server that receives client-side logged activity information from at least one client-side processing device in response to data communication with said remote server further comprises:
providing a server-side logging component that transmits a different marker to said client-side logging component for each client-side logging instance executing in said client execution environment of a corresponding processing device.

14. The method according to claim 8, wherein said providing a server-side logging component associated with a remote server that receives client-side logged activity information from at least one client-side processing device in response to data communication with said remote server further comprises:
providing a server-side logging component that transmits a receipt confirmation to a corresponding client-side logging component, so that logged activity information that is locally stored on a corresponding client-side processing device that has been acknowledged by said receipt confirmation is removed from a non-volatile storage associated with said client-side processing device.

15. A computer program product to implement an integrated logging system comprising:
a computer usable medium having computer usable program code embodied therewith, said computer usable program code comprising:
computer usable program code configured to implement a server-side logging component associated with a remote server that receives client-side logged activity information from at least one client-side processing device in response to data communication with said remote server, wherein said logged client-side activity information from each client-side processing device is asynchronously received by said server-side logging component and relates to the execution of a script within a client execution environment that is controlled and operated independently of said remote server;
computer usable program code configured to implement a server-side logging integration component that organizes server-side logged activity information and received client-side logged activity information into a server-side log that is stored in a a storage system; and
computer usable program code configured to implement an activity analysis component that conveys information from said server-side log to an analyst for problem determination with regard to script execution within said independently controlled and operated client execution environment.

16. The computer program product according to claim 15, wherein said computer usable program code configured to implement a server-side logging integration component comprises:
computer usable program code configured to transmit a marker to a client-side logging component associated with each client-side processing device, said marker comprising at least a start tag and server identification, wherein said marker is returned to said server-side logging component with said client-side logged activity received from each client-side processing device.

17. The computer program product according to claim 16, wherein:
said computer usable program code configured to transmit a marker to a client-side logging component associated with each client-side processing device further comprises:
computer usable program code configured to transmit a time stamp as part of said marker to said client-side logging component, said marker comprising at least a start tag and server identification; and
said computer usable program code configured to implement a server-side logging integration component further comprises:
computer usable program code configured to merge said logged client-side activity information in an appropriate time sequence with corresponding server-side activity information in said server-side log.

18. The computer program product according to claim 17, wherein:
said computer usable program code configured to merge said logged client-side activity information in an appropriate time sequence with corresponding server-side activity information in said server-side log further comprises computer usable program code configured to store said received client-side logged activity information in said server-side log by computing an offset of each activity based upon said timestamp.

19. The computer program product according to claim 16, wherein said computer usable program code configured to implement a server-side logging component further comprises computer usable program code configured to communicate said start tag to one or more additional related servers for distribution from each server to a corresponding one client-side processing device.

20. The computer program product according to claim 16, wherein said computer usable program code configured to implement a server-side logging component further comprises computer usable program code configured to transmit a different marker to said client-side logging component for each client-side logging instance executing in said client execution environment of a corresponding processing device.

21. The computer program product according to claim 15, wherein said computer usable program code configured to implement a server-side logging component further comprises:
computer usable program code configured to transmit a receipt confirmation to a corresponding client-side logging component, so that logged activity information that is locally stored on a corresponding client-side processing device that has been acknowledged by said receipt confirmation is removed from a non-volatile storage associated with said client-side processing device.
